(19) United States
(12) Patent Application Publication
(10) Pub. No.: US 2010/0155629 A1
(43) Pub. Date: Jun. 24, 2010

(54) PILOT VALVE FOR CONTROL VALVE

(76) Inventor: HARRY A. HUNNICUTT, Austin, TX (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/338,027

(22) Filed: Dec. 18, 2008

(51) Int. Cl. F16K 31/12

(52) U.S. Cl. 251/25

(57) ABSTRACT

A pilot-control valve assembly for a roll control system for a vehicle defines a pressure control valve assembly and includes a main stage valve and a pilot stage valve. A body of the main stage valve is press fit to a body of the pilot stage valve.

### BACKGROUND

Various embodiments of valves for controlling the flow of fluids in a fluid control system are described herein. In particular, the embodiments described herein relate to an improved pilot valve for a control valve in such a fluid control system.

Fluid control systems are widely known in the art and typically include a source of pressurized fluid that is connected through a conduit to a fluid operated device. Hydraulic fluid control systems use liquids, such as water or oil, to operate the fluid operated device. For example, many land vehicles are provided with a hydraulically controlled suspension system including a fluid pump that selectively provides pressurized liquid to one or more fluid actuated suspension members for controlling the ride and handling characteristics of the vehicle. Pneumatic fluid control systems use gases, such as air, to operate the fluid operated device. For example, many robots and other machines are provided with a pneumatically controlled linear actuator including an air pump that selectively provides pressurized gas to one or more movable members for controlling the extension and retraction thereof. In both hydraulic and pneumatic fluid control systems, one or more valves can be provided in the conduit for controlling the flow of the pressurized fluid to and from the source of pressurized fluid and the fluid operated device.

One type of valve assembly that is commonly used in a fluid control system is known as a pilot control valve assembly. Such a pilot control valve assembly is disclosed in U.S. Pat. No. 6,966,329 to Liberfarb. A typical pilot control valve assembly includes a pilot operated control valve and a pilot valve. Each valve typically includes a solid housing having a bore formed therein. Additionally, a plurality of passageways are formed in the housing that each communicate with the bore. One or more of the passageways communicate with the source of pressurized fluid, while one or more of the other passageways communicate with the fluid operated device. The pilot valve is provided in communication with the control valve for selectively controlling fluid communication between the various passageways of the control valve and, thereby, selectively controlling the operation of the fluid control system.

To accomplish this, the pilot valve typically uses controlled fluid pressure to position a flow control member, such as a spool or gate, of the control valve. The flow control member is typically disposed within the bore of the control valve and selectively controls fluid flow through a plurality of ports formed in the main body of the control valve.

One type of commonly used pilot valve is a solenoid pilot valve. The solenoid pilot valve includes an electro-magnetically actuated armature that controls the flow of fluid through one or more lands, grooves, passageways or other structures provided in the pilot valve housing.

### SUMMARY

The present application describes various embodiments of a pilot-control valve assembly for a roll control system for a vehicle. One embodiment of the pilot-control valve assembly includes a main stage valve and a pilot stage valve. A body of the main stage valve is press fit to a body of the pilot stage valve. Other advantages of the pilot-control valve assembly will become apparent to those skilled in the art from the following detailed description, when read in light of the accompanying drawings.

### BRIEF DESCRIPTION OF THE DRAWINGS

FIG. 1 is a schematic diagram of a first embodiment of a roll control system for a vehicle including a first embodiment of a pilot control valve assembly.

FIG. 2 is an enlarged cross-sectional view of the first embodiment of the pilot control valve assembly illustrated in FIG. 1.

FIG. 3 is a cross-sectional view of a first alternate embodiment of the pilot poppet valve illustrated in FIG. 1.

FIG. 4 is a cross-sectional view of a second alternate embodiment of the pilot poppet valve illustrated in FIG. 1.

FIG. 5 is a schematic diagram of a second embodiment of a roll control system for a vehicle including a second embodiment of a pilot control valve assembly.

FIG. 6 is a cross-sectional view of a third embodiment of the pilot control valve assembly.

FIG. 7 is a cross-sectional view of a fourth embodiment of the pilot control valve assembly.

FIG. 8 is a cross-sectional view of a fifth embodiment of the pilot control valve assembly.

FIG. 9 is a cross-sectional view of a third alternate embodiment of the pilot poppet valve.

### DETAILED DESCRIPTION

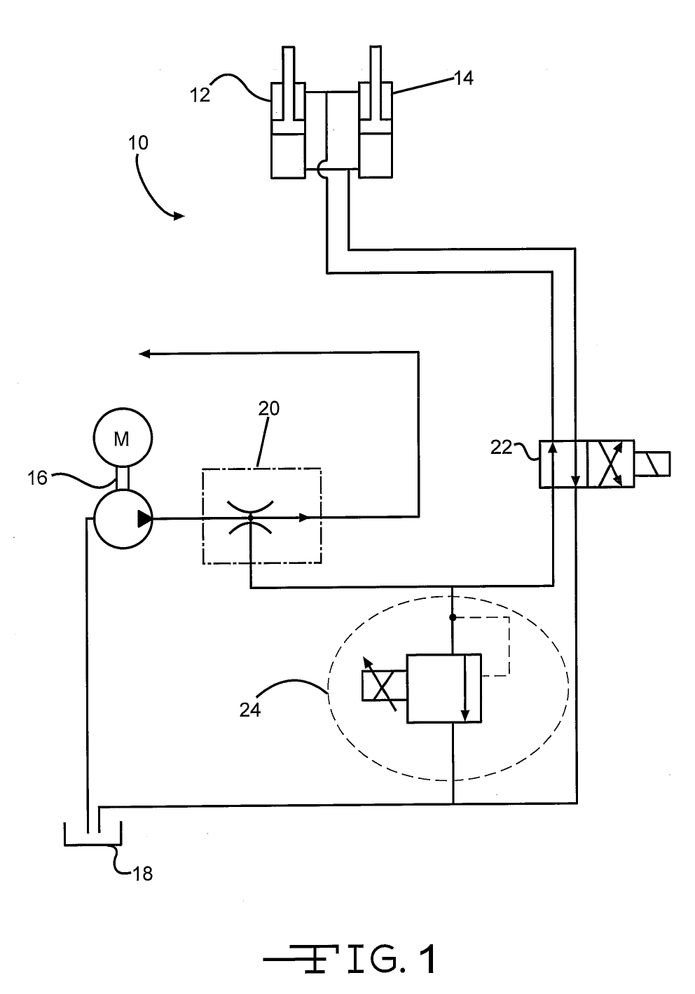

Referring now to the drawings, there is illustrated in FIG. 1 a roll control system, indicated generally at 10, for a vehicle, including a first embodiment of a pilot control valve assembly, indicated generally at 24. The general structure and operation of the roll control system 10 is conventional in the art. Thus, only those portions of the roll control system 10 which are necessary for understanding the present invention will be discussed herein. Also, although the pilot control valve assembly 24 will be discussed in connection with the roll control system 10 illustrated and described herein, it will be appreciated that the pilot control valve assembly 24 may be used in connection with other types of fluid systems.

In the illustrated embodiment, the roll control system 10 includes a pair of suspension actuators 12 and 14. The suspension actuators are hydraulic actuators such as used in active suspension systems. The actuators 12 and 14 are placed on opposite sides of a vehicle (not shown) to actively impose loads on one side or the other of a vehicle to control the roll of the vehicle during travel.

In the illustrated embodiment, the roll control system 10 includes a pump-motor unit 16 to provide pressurized hydraulic fluid. The pump-motor unit 16 is in communication with a fluid reservoir 18 that is a source of hydraulic fluid for the pump-motor unit 16. The pump-motor unit 16 may optionally also provide pressurized hydraulic fluid to one or more other systems (not shown) of the vehicle. To accomplish this in the illustrated embodiment, the pump-motor unit 16 is in fluid communication with a priority flow diverter 20 that directs fluid flow between the roll control system 10 and the other systems, such as a steering system or any other system in the vehicle that requires pressurized hydraulic fluid.

In the illustrated embodiment, the roll control system 10 includes a two-state solenoid valve 22 that is in fluid communication with the pump-motor unit 16 and the actuators 12 and 14. The solenoid valve 22 may be in a first, e.g., normal, position (as shown in FIG. 1), such that the valve 22 directs pressured hydraulic fluid to a first end of each of the actuators 12 and 14 so as to thereby compress the actuators 12 and 14. The valve 22 may be in a second or actuated position (not shown) so as to direct pressurized hydraulic fluid to a second end of each of the actuators 12 and 14 so as to thereby extend the actuators 12 and 14.

The solenoid valve 22 is also in communication with the reservoir 18 such that in the first position hydraulic fluid is permitted to flow from the second ends of the actuators 12 and 14 to the reservoir 18. In the second position hydraulic fluid is permitted to flow from the first ends of the actuators 12 and 14 to the reservoir 18.

The pilot control valve assembly 24 is in fluid communication with the pump-motor unit 16 and with the reservoir 18. The pilot control valve assembly 24 is able to divert at least a portion of the hydraulic fluid flow from the pump-motor assembly 16 away from the actuators 12 and 14 and to the reservoir 18 and thus regulate the amount of pressurized fluid going to the actuators 12 and 14, and thus control the amount of change in the suspension system of the vehicle.

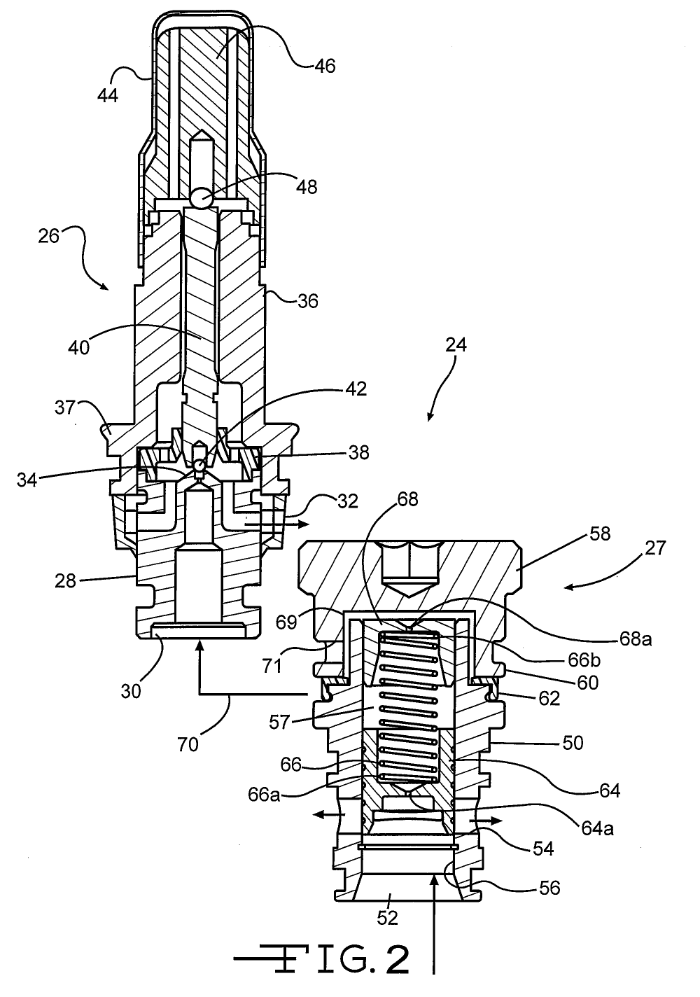

Referring now to FIG. 2, there is shown an enlarged cross-sectional view of the first embodiment of the pilot control valve assembly 24. In the illustrated embodiment, the pilot control valve assembly 24 includes a solenoid operated pilot poppet valve 26 and a pilot-operated control or main stage valve 27.

In the illustrated embodiment, the pilot valve 26 includes a pilot valve body 28 having an inlet 30 and an outlet 32. The pilot valve body 28 defines a pilot valve seat 34. The pilot valve 26 also includes a poppet sleeve 36 connected to the pilot valve body 28. The poppet sleeve 36 includes a clinched gland portion 37 suitable for fixing the pilot valve 26 into a valve housing (not shown) of the pilot control valve assembly 24, although any suitable method for installing the pilot valve 26 to the valve housing may be used. A flow through seal 38 is disposed between the pilot valve body 28 and the poppet sleeve 36.

As shown in the illustrated embodiment, the pilot valve 26 has a removable seat 34, although such is not required. In such a case, the pilot valve 26 can be partially disassembled, to remove the seat 34, which provides for improved ease of field service as well as ease of testing.

In the illustrated embodiment, the pilot valve 26 includes a poppet stem 40 disposed within the poppet sleeve 36 and a pilot blocking member 42 for contacting the pilot valve seat 34. The blocking member 42 is shown as a ball bearing which is pressed into an opening provided in a first end of the poppet stem 40. Alternatively, the pilot blocking member 42 may be any other suitable kind of device which is capable of preventing or restricting the flow of fluid through the pilot valve 26. The pilot blocking member 42 may be an integral part of the poppet stem 40.

In the illustrated embodiment, the pilot valve 26 further includes an armature tube or sleeve 44 connected to the poppet sleeve 36 opposite the pilot valve body 28. An armature 46 is disposed within the armature sleeve 44 and includes a poppet stem contact member 48. In the illustrated embodiment, the contact member 48 is shown as a ball bearing pressed into an opening provided in an end of the armature 46. Alternatively, the contact member 48 may be any other suitable device capable of at least partially axially position the armature 46 when in contact with the poppet stem 38. The contact member may be an integral part of the armature 46.

In operation, electrical windings (not shown) position the armature 46 within the armature sleeve 44 by electro-magnetic forces. The poppet stem 38 is thus, in turn, positioned by the armature 46 and thereby controls the amount of fluid flow though the pilot valve body 28. Alternatively, the construction of the pilot valve 26 may be other than illustrated if so desired.

In the illustrated embodiment, the main pilot-operated control valve 27 includes a main valve body 50 having an inlet 52 and an outlet 54. The main valve body 50 is generally formed as a hollow cylinder which defines an inner wall surface 56. The main valve body 50 also defines a chamber 57, which is open at one axial end to communicate with the inlet 52. The outlet 54 is formed radially through the main valve body 50 and the inner wall surface 56 to communicate with the chamber 57.

In the illustrated embodiment, the main pilot-operated control valve 27 also includes an end plug 58 for fixing the main valve body 50 into the valve housing of the pilot control valve assembly 24. The end plug 58 includes a clinched gland portion 60 suitable for fixing the main pilot-operated control valve 27 into the valve housing. Alternatively, any other suitable method for installing the main pilot-operated control valve 27 in the valve housing may be used if so desired. A seal 62 is disposed between the main valve body 50 and the end plug 58.

In the illustrated embodiment, the main pilot-operated control valve 27 includes a first or blocking member in the form of a spool 64. The spool 64 is disposed within the chamber 57. The spool 64 defines an axially extending orifice 64a therethrough, the purpose of which will be described below. The spool 64 slidingly engages the inner wall surface 56 to selectively block (cover) the outlet 54 to prevent communication between the chamber 57 and the outlet 54. It must be understood that the spool 64 may be any device suitable to restrict or prevent fluid flow though the main pilot-operated control valve 27 between the inlet 52 and the outlet 54.

In the illustrated embodiment, the spool 64 is biased toward a closed position (shown in FIG. 2) by a spring 66. A first end 66a of the spring 66 engages the spool 64, a second end 66b of the spring 66 engages a retainer 68, and the spring 66 is compressed therebetween. In the illustrated embodiment, the spring 66 has a very low spring rate. Therefore, the spring 66 makes an insignificant contribution to the net balance of forces acting on the spool.

The retainer 68 is press fit into the main valve body 50 to provide a desired preload on the spring 66. The retainer 68 has an opening 68a formed axially therethrough. By means of the opening 68a, fluid in the chamber 57 can communicate with a chamber 69 defined between the retainer 68 and the end plug 58. A fluid conduit 70 (which may be formed in a common valve block (not shown) in which both the pilot valve 26 and the main pilot-operated control valve 27 are mounted) provides fluid communication between the chamber 69, via an outlet 71, and the inlet 30 of the pilot valve 26.

In the main pilot-operated control valve 27, the pressure in the chamber 57, the spring 66, and the pressure in the inlet all exert axial forces on the spool 64. When the spool 64 is at equilibrium in operation, the axial forces on the spool 64 sum up to zero. That means that the pressure P1 in the inlet 52 in front of the spool 64 times the cross sectional area A of the spool 64 will equal the spring force F plus the pressure P2 in the chamber 57 on the back side of the spool 64 times the spool cross sectional area A.

P1*A=F+P2*A (equation 1)

Rearranging the terms, one can see that there is the pressure drop across the spool 64, P1−P2, is equal to the spring force F divided by the cross sectional area A of the spool:

P1−P2=F/A (equation 2)

Since the spool 64 moves very little between a position blocking the outlet 54 and a position in which the outlet 54 is uncovered by the spool 64, the force F exerted by the spring 66 is substantially unchanged through the range of motion of the spool 64. Accordingly, since the cross-sectional area of the spool 64 is constant, according to equation 2, the pressure drop across the spool 64 is essentially constant and fixed.

Because there is a fixed pressure drop across the spool 64, there is fixed flow through the orifice 64a through the spool 64, and thence through the chamber 57, the opening 68a through the retainer 68, the chamber 69, and the fluid conduit 70 to the pilot valve 26. This is the fluid that flows through the pilot valve 26.

Fluid flow through the respective pilot valves of known pilot operated valves is a function of system pressure. Such fluid flow to the pilot valves of known pilot operated valves can not be used to move actuators, such as the actuators 12 and 14.

The pilot valve 26 is operated to control the pressure in the chamber 57 in the back of the spool 64, and thus (given the pressure drop) control the pressure at the inlet 52. In order to raise pressure supplied to the actuators 12, 14, the pilot valve 26 is actuated toward a closed position. This increases the pressure drop across the pilot valve 26, raising the pressure in the pilot valve 26 inlet 30, and via the fluid conduit 70, the chamber 57. Since the pressure drop across the spool 64 is constant in steady state, the spool 64 moves to more fully block the outlet 54, so that pressure in the inlet 52 of the pilot-operated valve 27 increases until the pressure drop across the spool 64 is restored to the steady state value, equal to F/A. This results in raised pressure at the inlet 52 of the pilot-operated valve 27, which is the pressure supplied via the switching valve 22 to the actuators 12, 14 (see FIG. 1). To lower the pressure supplied to the actuators 12, 14, the pilot valve 26 is operated to open, leading to a lowering of the pressure in the chamber 57, and, because of the pressure drop across the spool 64, a lowering of the pressure at the inlet 52 of the pilot-operated valve 27, and thus to the actuators 12, 14.

During such operation the armature 46 is centered, or at least partially axially guided by the poppet stem 40. This means that at most only a portion of the travel of the armature 46 is guided by the armature sleeve 44. In such a case, the clearance between the armature 46 and the armature sleeve 44 are not as critical as if the armature 46 were fully guided by the armature sleeve and thus the manufacture and finish of the armature 46 and armature sleeve 44 need not be as precise.

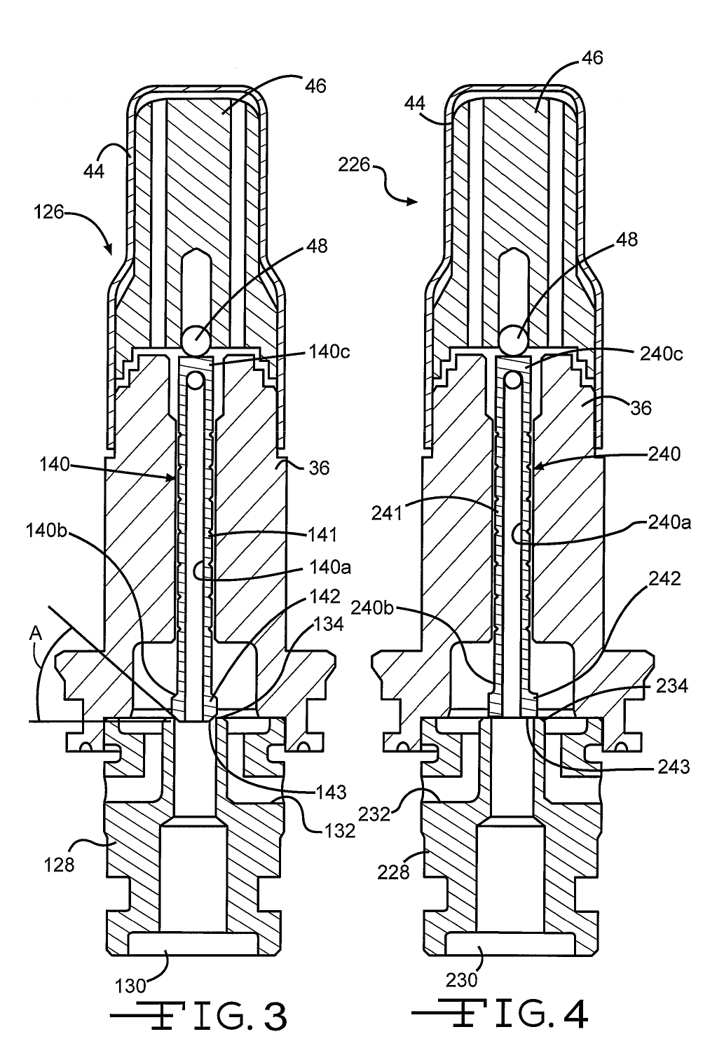

Referring now to FIG. 3, there is illustrated a first alternate embodiment of a pilot poppet valve, indicated generally at 126. The pilot poppet valve 126 is generally similar to the pilot valve 26 of FIG. 2, and like reference numbers are used to indicate similar parts. The illustrated embodiment of the pilot poppet valve 126 includes a poppet stem 140 having a body 141 and integrally formed flared blocking member 142. The blocking member 142 has a diameter larger than the diameter of the body of 141 of the poppet stem 140. The poppet stem 140 further includes an internal passageway 140a to allow fluid to travel from a first end 140b of the poppet stem 140 toward a second end 140c thereof.

In the illustrated embodiment, the pilot valve 126 includes a pilot valve body 128 having an inlet 130 and an outlet 132. The pilot valve body 128 defines a pilot valve seat 134. The pilot valve 126 also includes the poppet sleeve 36 connected to the pilot valve body 128.

In the illustrated embodiment, the pilot valve 126 includes the poppet stem 140 disposed within the poppet sleeve 36 and the pilot blocking member 142 for contacting the pilot valve seat 134. The illustrated blocking member 142 has a surface 143 for contacting the valve seat 134. The illustrated surface 143 is formed at an angle A of about 45 degrees. Alternatively, the construction of the pilot valve 126 may be other than illustrated if so desired.

Referring now to FIG. 4, there is illustrated a second alternate embodiment of a pilot poppet valve, indicated generally at 226. The pilot poppet valve 226 is generally similar to the pilot poppet valve 126 of FIG. 3, and like reference numbers are used to indicate similar parts. The illustrated embodiment of the pilot poppet valve 226 includes a poppet stem 240 having a body 241 and integrally formed flared blocking member 242. The blocking member 242 has a diameter larger than the diameter of the body of 241 of the poppet stem 240. The poppet stem 240 further includes an internal passageway 240a to allow fluid to travel from a first end 240b of the poppet stem 240 toward a second end 240c thereof.

In the illustrated embodiment, the pilot valve 226 includes a pilot valve body 228 having an inlet 230 and an outlet 232. The pilot valve body 228 defines a pilot valve seat 234. The pilot valve 126 also includes the poppet sleeve 36 connected to the pilot valve body 228.

In the illustrated embodiment, the pilot valve 226 includes the poppet stem 240 disposed within the poppet sleeve 36 and the pilot blocking member 242 for contacting the pilot valve seat 234. The first end 240b of the illustrated blocking member 242 has a substantially flat surface 243 (horizontal when viewing FIG. 4) for contacting the valve seat 234. Alternatively, the construction of the pilot valve 226 may be other than illustrated if so desired.

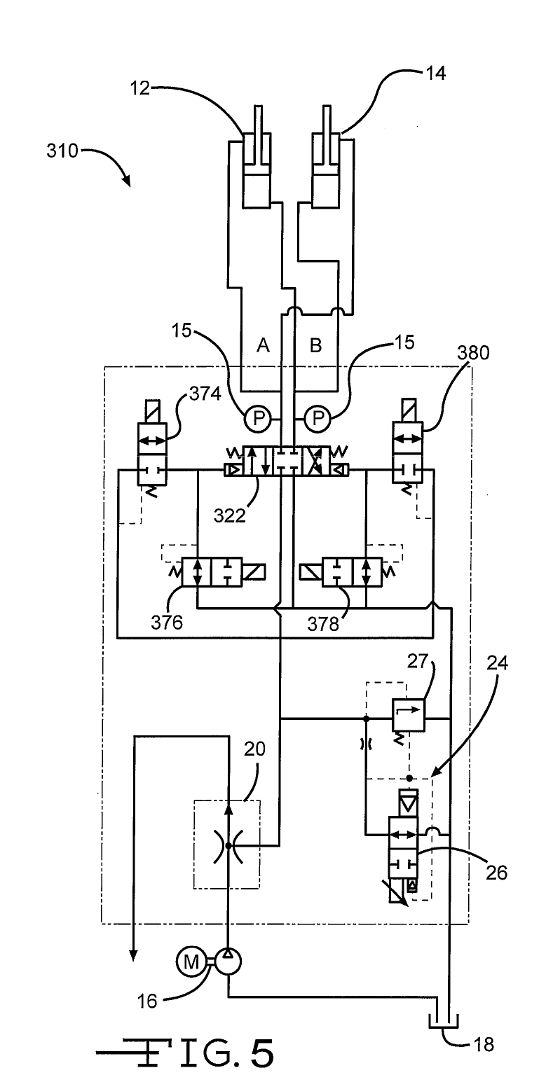

Referring now to FIG. 5, there is illustrated a second embodiment of a roll control system, indicated generally at 310. The roll control system 310 is generally similar to the embodiment of the roll control system 10 illustrated in FIG. 1, and like reference numbers are used to indicate similar parts. The illustrated embodiment of the roll control system 310 includes a three-state hydraulically actuated directional valve 322 to allow for open, closed (as shown in FIG. 5), and cross-over states. The valve 322 is operated by a series of solenoid valves; including normally closed valves 374 and 380, and normal open valves 376 and 378.

As described herein above regarding the roll control system 10, the pilot control valve assembly 24 is in fluid communication with the pump-motor unit 16 and with the reservoir 18. The pilot control valve assembly 24 is able to divert at least a portion of the hydraulic fluid flow from the pump-motor assembly 16 away from the actuators 12 and 14 and to the reservoir 18 and thus regulate the amount of pressurized fluid going to the actuators 12 and 14, and thus control the amount of change in the suspension system of the vehicle. The pilot control valve assembly 24 includes the solenoid operated pilot poppet valve 26 and the main pilot-operated control valve 27. It will be understood however, that the roll control system 310 may include alternate embodiments of the control valve assembly, such as for example, the embodiments described herein below.

In the illustrated embodiment of the roll control system 310, the three-state valve 322 is in fluid communication with the pump-motor unit 16 and the actuators 12 and 14. The exemplary embodiment illustrated also includes a pressure transducer 15 disposed between the first and second ends of the actuators 12 and 14, respectively.

It will be further understood that additional embodiments of the pilot-control valve assembly may include a solenoid operated pilot poppet valve pressed onto a pilot-operated control valve, such as shown in FIGS. 6 through 8, as described in detail herein below.

Referring now to FIG. 6, there is illustrated a second embodiment of a pilot control valve assembly wherein a solenoid operated pilot poppet valve pressed onto a pilot-operated control valve, shown generally at 424. The valve assembly 424 has components in common with the pilot poppet valves 126 and 226 of FIGS. 3 and 4, respectively, and like reference numbers are used to indicate similar parts. The valve 424 includes a solenoid operated pilot poppet valve portion 426 and a pilot operated control valve portion 427.

The illustrated pilot valve portion 426 includes the pilot valve body 428 having an inlet 430. The pilot valve body 428 defines a pilot valve seat 434. The pilot valve portion 426 also includes a poppet sleeve 436 having a first end 436a, a second end 436b, and stepped longitudinal bore 435 therethrough. The outlet 432 is formed radially from the bore 435 through the sleeve 436. The outlet 432 is formed at an angle B from an axis A of the sleeve 436. The illustrated outlet 432 is formed at an angle B of about 45 degrees. It will be understood however, that the outlet 432 may be formed at any desired angle B from the axis A of the sleeve 436.

The poppet sleeve 436 includes a clinched gland portion 437 suitable for fixing the pilot control valve assembly 424 into a valve housing (not shown), although any suitable method for installing the pilot control valve assembly 424 to the valve housing may be used. As shown in the illustrated embodiment, a pilot valve body 428 is inserted into the bore 435 at the second end 436B of the sleeve 436.

In the illustrated embodiment, the pilot control valve assembly 424 includes a poppet stem 440 disposed within the poppet sleeve 436. The illustrated stem 440 includes a first portion 440a and a second portion 440b (below the first portion 440A when viewing FIG. 6). The second portion 440B includes a pilot blocking member 442 formed at a second end 441 of the second portion 440B. The blocking member 442 is structured and configured for contacting the pilot valve seat 434.

In the illustrated embodiment, the main pilot operated control valve portion 427 includes a main valve body 450 having an inlet 452 and an outlet 454. The main valve body 450 is generally formed as a hollow cylinder having a first end 450a, a second end 450b, and an inner wall surface 456 defining a bore 459. The main valve body 450 also defines a chamber 457. The illustrated outlet 454 is formed radially from the inner wall surface 456 through the body 450. In the embodiment illustrated in FIG. 6, a generally cylindrical retainer or insert 458 is inserted within the bore 459 at the second end of the body 450 to retain the spool 464 within the bore 459.

In the illustrated embodiment, the main pilot-operated control valve 427 includes a first or blocking member in the form of a spool 464. The spool 464 is disposed within the chamber 457. The spool 464 defines an axially extending orifice 464a therethrough. The spool 464 slidingly engages the inner wall surface 456 to selectively block or cover the outlet 454 to prevent communication between the chamber 457 and the outlet 454. It will be understood that the spool 464 may be any device suitable to restrict or prevent fluid flow though the main pilot-operated control valve 427 between the inlet 452 and the outlet 454.

In the illustrated embodiment, the spool 464 is biased toward a closed position (shown in FIG. 6) by a spring 466. A first end 466a of the spring 466 engages the spool 464, a second end 466b of the spring 466 engages the second end 436b of the sleeve 436, and the spring 466 is compressed therebetween.

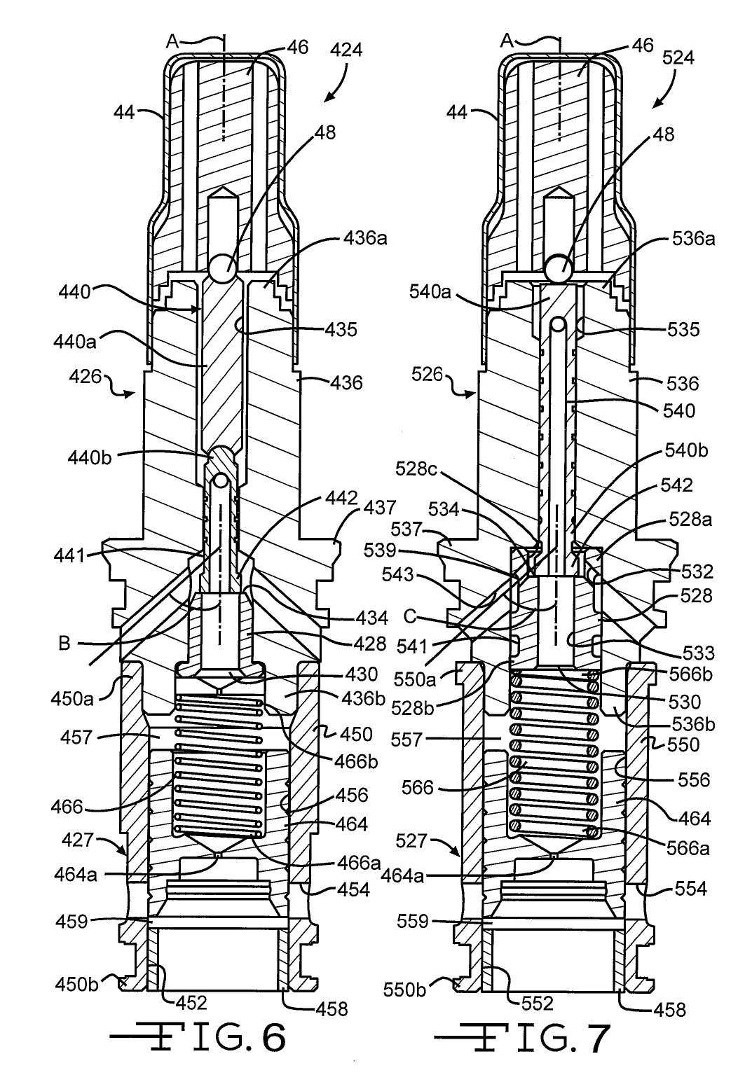

Referring now to FIG. 7, there is illustrated a third embodiment of a pilot control valve assembly wherein a solenoid operated pilot poppet valve pressed onto a pilot-operated control valve, shown generally at 524. The valve assembly 524 has components in common with the pilot control valve assembly 424 in FIG. 6, and like reference numbers are used to indicate similar parts. The valve 524 includes a solenoid operated pilot poppet valve portion 526 and a pilot operated control valve portion 527.

The illustrated pilot valve portion 526 includes a pilot valve body 528 having an inlet 530 and an outlet 532. The pilot valve body 528 defines a pilot valve seat 534. The pilot valve portion 526 also includes a poppet sleeve 536 having a first end 536a, a second end 536b, and stepped longitudinal bore 535 therethrough. The outlet 543 is formed radially from the bore 535 through the sleeve 536. The outlet 543 is formed at an angle C from an axis A of the sleeve 536. The illustrated outlet 532 is formed at an angle C of about 45 degrees. It will be understood however, that the outlet 532 may be formed at any desired angle C from the axis A of the sleeve 536.

The poppet sleeve 536 includes a clinched gland portion 537 suitable for fixing the pilot control valve assembly 524 into a valve housing (not shown), although any suitable method for installing the pilot control valve assembly 524 to the valve housing may be used. As shown in the illustrated embodiment, the pilot valve body 528 is inserted into the bore 535 at the second end 536b of the sleeve 536. The illustrated body 528 is generally cylindrical in shape and has a first end 528a, a second end 528b, and a longitudinal bore 533 therethrough. A generally cylindrical cavity 528c is formed in an end surface of the first end 528a. A first circumferentially extending groove 539 and a second circumferentially extending groove 541 are formed in an outer surface of the body 531. The second groove 541 defines a seat for a seal, such as an O-ring (not shown). Bores are formed radially from the cavity 528c through the seat body 528 to the first groove 539 and define the outlet 532. The bores 543 are formed at the angle C from the axis A of the sleeve 536. The illustrated bores 543 is formed at an angle C of about 45 degrees. It will be understood however, that the bores 543 may be formed at any desired angle C from the axis A of the sleeve 536.

In the illustrated embodiment, the pilot control valve assembly 524 includes a poppet stem 540 disposed within the poppet sleeve 536. The illustrated stem 540 has first end 540a, a second end 540b and a pilot blocking member 542 formed at a second end 540b thereof. The blocking member 542 is structured and configured for contacting the pilot valve seat 534.

In the illustrated embodiment, the main pilot operated control valve portion 527 includes a main valve body 550 having an inlet 552 and an outlet 554. The main valve body 550 is generally formed as a hollow cylinder having a first end 550a, a second end 550b, and an inner wall surface 556 defining a bore 559. The main valve body 550 also defines a chamber 557. The illustrated outlet 554 is formed radially from the inner wall surface 556 through the body 550. In the embodiment illustrated in FIG. 7, the retainer 458 is inserted within the bore 559 at the second end 550b of the body 550.

In the illustrated embodiment, the main pilot-operated control valve portion 527 includes the spool 464 disposed within the chamber 457. In the illustrated embodiment, the spool 464 is biased toward a closed position (shown in FIG. 7) by a spring 566. A first end 566a of the spring 566 engages the spool 464, a second end 566b of the spring 566 engages the second end 528b of the pilot valve body 528, and the spring 566 is compressed therebetween.

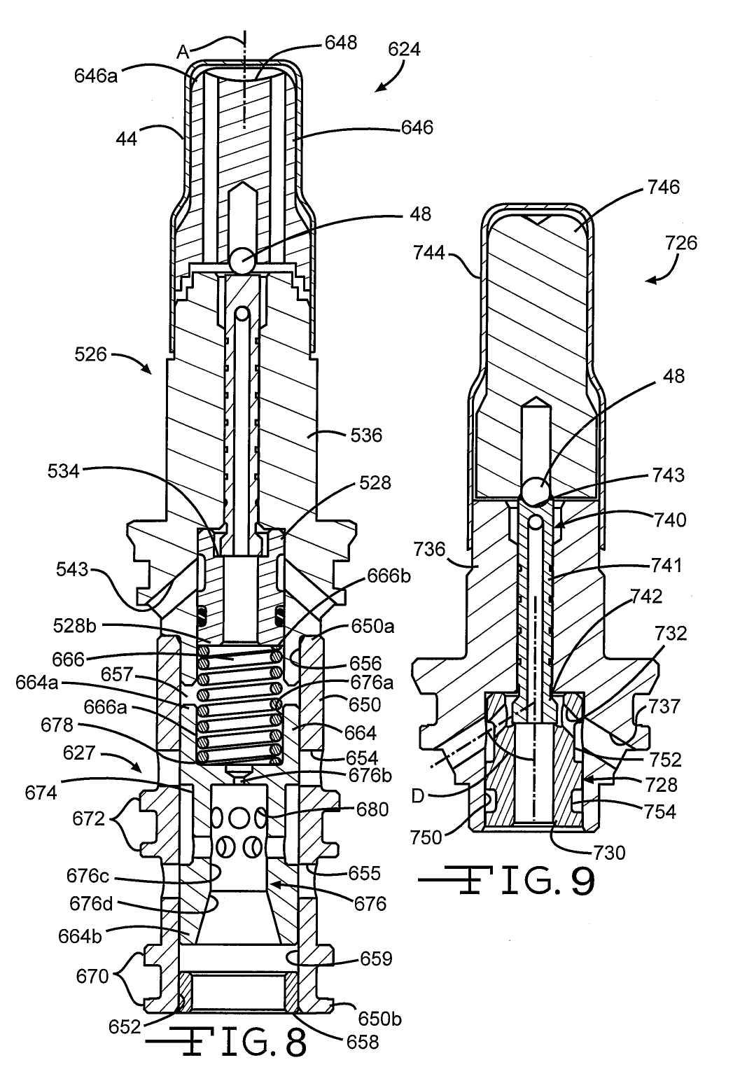

Referring now to FIG. 8, there is illustrated a fourth embodiment of a pilot control valve assembly wherein a solenoid operated pilot poppet valve pressed onto a pilot-operated control valve, shown generally at 624. The valve assembly 624 has components in common with the pilot control valve assemblies 424 in FIG. 6, and 524 in FIG. 7, and like reference numbers are used to indicate similar parts. The valve 624 includes the solenoid operated pilot poppet valve portion 526 and a pressure reducing valve portion 627. The pilot poppet valve portion 526 includes an armature 646 having a semispherical concave surface 648 formed at the first end 646a thereof.

In the illustrated embodiment, the main pilot operated control valve portion 627 includes a main valve body 650 having an inlet 652, a first outlet 654, and a second outlet 655. The main valve body 650 is generally formed as a hollow cylinder having a first end 650a, a second end 650b, and an inner wall surface 656 defining a bore 659. The main valve body 650 also defines a chamber 657. The illustrated outlets 654 and 655 are formed radially from the inner wall surface 656 through the body 650. In the embodiment illustrated in FIG. 8, a retainer 658 is inserted within the bore 659 at the second end 650b of the body 650. A first pair of flanges 670 extend radially outwardly of the body 650 at the second end 650b. A second pair of flanges 672 extends radially outwardly of the body 650 intermediate the first end 650a and the second end 650b.

In the illustrated embodiment, the pressure reducing valve portion 627 includes a spool 664 disposed within the chamber 657. The illustrated spool 664 is substantially cylindrical and has a first end 664a and a second end 664b. A circumferential groove 674 is formed in an outer surface of the spool 664. An axial bore 676 is formed through the spool 664 and include four portions. A first portion 676a is formed at the first end 664a of the spool 664 and defines a spring seat 678. A second or reduced diameter portion 676b extends outwardly (downwardly when viewing FIG. 8) from the first portion 676a, and defines an orifice. A generally cylindrical third portion 676c extends outwardly (downwardly when viewing FIG. 8) from the second portion 676b. A plurality of bores 680 extend radially outwardly from the third portion 676c to the circumferential groove 674. A tapered fourth bore portion 676d extends outwardly (downwardly when viewing FIG. 8) from the third portion 676c to the second end 664b of the spool 664. In the illustrated embodiment, the fourth portion 676d increases in diameter from the third portion 676c to the second end 664b of the spool 664.

In the illustrated embodiment, the spool 664 is biased toward a closed position (shown in FIG. 7) by a spring 666. A first end 666a of the spring 666 engages the spool 464, a second end 666b of the spring 666 engages the second end 528b of the pilot valve body 528, and the spring 666 is compressed therebetween.

Additionally, as best shown in FIG. 9, it will be understood that the solenoid operated pilot poppet valve may be configured as desired with the pilot valve body fully or partially disposed within the poppet sleeve.

There is illustrated in FIG. 9, a second alternate embodiment of a pilot poppet valve, indicated generally at 726.

In the illustrated embodiment, the pilot poppet valve 726 further includes an armature sleeve 744 connected to the poppet sleeve 736. The poppet sleeve 736 includes the outlet 737 formed radially from the bore 750 through the sleeve 736. An armature 746 is disposed within the armature sleeve 744 and includes the poppet stem contact member or ball bearing 48 pressed into an opening provided in an end of the armature 746. The ball bearing 48 is also seated in a semi-spherical depression 743 formed in an end of the poppet stem 740. Alternatively, the contact member 48 may be formed as an integral part of the armature 746.

The illustrated poppet stem 740 includes a body 741 and an integrally formed flared blocking member 742. The pilot valve body 728 is disposed in the bore 750 of the sleeve 736 (lower end of the sleeve 736 when viewing FIG. 9). The pilot valve body 728 includes an inlet 730 and an outlet 732 fluidly connected to the outlet 737 of the pilot sleeve 736. A first circumferentially extending groove 752 and a second circumferentially extending groove 754 are formed in an outer surface of the body 728. The second groove 754 defines a seat for a seal, such as an O-ring (not shown).

The outlets 732 and 737 are formed at the angle D from the axis A of the sleeve 736. The illustrated outlets 732 and 737 are formed at an angle D of about 45 degrees. It will be understood however, that the outlets 732 and 737 may be formed at any desired angle D from the axis A of the sleeve 736.

The principle and mode of operation of the pilot valve for a control valve in a fluid control system have been described in its preferred embodiment. However, it should be noted that the pilot valves described herein may be practiced otherwise than as specifically illustrated and described without departing from its scope.

What is claimed is:

1. A pilot-control valve assembly for a roll control system for a vehicle, the pilot-control valve assembly defining a pressure control valve assembly and comprising:
a main stage valve; and
a pilot stage valve;
wherein a body of the main stage valve is press fit to a body of the pilot stage valve.

2. The pilot-control valve assembly according to claim 1, wherein the main stage valve is a pilot operated pressure control valve.

3. The pilot-control valve assembly according to claim 2, wherein the main stage valve has a first and second end, and the pilot stage valve has a first and second end, and wherein the second end of the pilot stage valve is press fit within an opening in the first end of the main stage valve.

4. The pilot-control valve assembly according to claim 3, wherein the pilot stage valve is a solenoid operated pilot poppet valve.

5. The pilot-control valve assembly according to claim 4, wherein the pilot stage valve includes a body defining a valve seat, a poppet sleeve, an armature sleeve, a poppet stem, and an armature slidably mounted within the armature sleeve; and
wherein the armature is centered within the armature sleeve by the poppet stem.

6. The pilot-control valve assembly according to claim 5, wherein the valve seat is selectively removable from the poppet sleeve during any one of assembly and maintenance of the pilot-control valve assembly.

7. The pilot-control valve assembly according to claim 5, wherein the valve seat is sealed within a bore of the poppet sleeve.

8. The pilot-control valve assembly according to claim 7, wherein the valve seat is sealed within a bore of the poppet sleeve with an O-ring.

9. The pilot-control valve assembly according to claim 5, wherein the armature is guided within the armature sleeve by the poppet stem during operation of the pilot stage valve.

10. The pilot-control valve assembly according to claim 5, wherein the poppet stem is formed in two parts.

11. The pilot-control valve assembly according to claim 1, wherein the main stage valve is a pilot operated pressure reducing valve.

12. The pilot-control valve assembly according to claim 11, wherein the main stage valve has a first and second end, and the pilot stage valve has a first and second end, and wherein the second end of the pilot stage valve is press fit within an opening in the first end of the main stage valve.

13. The pilot-control valve assembly according to claim 12, wherein the pilot stage valve is a solenoid operated pilot poppet valve.

14. The pilot-control valve assembly according to claim 13, wherein the pilot stage valve includes a body defining a valve seat, a poppet sleeve, an armature sleeve, a poppet stem, and an armature slidably mounted within the armature sleeve; and wherein the armature is centered within the armature sleeve by the poppet stem.

15. The pilot-control valve assembly according to claim 14, wherein the valve sat is selectively removable from the poppet sleeve during any one of assembly and maintenance of the pilot-control valve assembly.

16. The pilot-control valve assembly according to claim 14, wherein the valve seat is sealed within a bore of the poppet sleeve.

17. The pilot-control valve assembly according to claim 16, wherein the valve seat is sealed within a bore of the poppet sleeve with an O-ring.

18. The pilot-control valve assembly according to claim 14, wherein the armature is guided within the armature sleeve by the poppet stem during operation of the pilot stage valve.

19. The pilot-control valve assembly according to claim 14, wherein the poppet stem is formed in two parts.

20. A pilot-control valve assembly for a roll control system for a vehicle, the pilot-control valve assembly defining one of a pressure control valve assembly and a pressure reducing valve assembly and comprising:
a main stage valve; and
a pilot stage valve;
wherein a body of the main stage valve is press fit to a body of the pilot stage valve;
wherein the main stage valve is one of a pilot operated pressure control valve and a pilot operated pressure reducing valve; and
wherein the main stage valve has a first and second end, and the pilot stage valve has a first and second end, and wherein the second end of the pilot stage valve is press fit within an opening in the first end of the main stage valve.
